(19) United States
(12) Patent Application Publication
(10) Pub. No.: US 2016/0119320 A1
(43) Pub. Date: Apr. 28, 2016

(54) METHOD AND SYSTEM FOR SECURE DEPLOYMENT AND USE OF BLUETOOTH LOW ENERGY BEACONS AND OTHER NETWORK DEVICES

(71) Applicant: AISLELABS INC., TORONTO (CA)

(72) Inventors: NILESH BANSAL, TORONTO (CA); NIKOLAOS KOUDAS, TORONTO (CA)

(21) Appl. No.: 14/921,885

(22) Filed: Oct. 23, 2015

Related U.S. Application Data
(60) Provisional application No. 62/067,489, filed on Oct. 23, 2014.

(51) Int. Cl. H04L 29/06; G06Q 30/02; H04W 4/02; H04W 4/00; H04W 52/02

(52) U.S. Cl. CPC H04L 63/083; H04W 4/008; H04W 52/0229; H04W 4/02; G06Q 30/0248; G06Q 30/0225

(57) ABSTRACT

A network security system is provided to secure one or more digital commerce or advertising processes for one more users, based on the presence of the one or more users in the proximity of one or more beacons. One or more coordinating components are associated with the beacons, and these provide an identifier uniquely to the one or more users. One or more security components are configured to automatically modify an identifier associated with each beacon, based on a predetermined pattern. One or more network connected devices associated with the one or more users, receive modified identifier, process one or more data elements, and communicate with a server computer or computer network service. The server computer or computer network service received the modified identifier, and based on the predetermined pattern, determine whether the modified identifier is the same as the expected identifier for the beacon based on the predetermined pattern, and uses this information to authenticate the beacon, and based on this authentication authorize the one or more digital commerce or advertising processes. A related method for providing network security is provided. Related systems and methods are provided for securing beacons, and deploying and managing beacons.

### CROSS-REFERENCE TO RELATED APPLICATION(S)

This application claims all benefit, including priority, of U.S. Provisional Patent Application Ser. No. 62/067,489, filed Oct. 23, 2014 and entitled METHOD AND SYSTEM FOR SECURE DEPLOYMENT AND USE OF BLUETOOTH LOW ENERGY BEACONS AND OTHER NETWORK DEVICES, the contents of which is incorporated herein by reference, in its entirety.

### FIELD

The embodiments disclosed herein generally relate to the field of network devices, and more particularly to systems and methods for secure deployment and use of Bluetooth low energy beacons.

### INTRODUCTION

Bluetooth Low Energy or Bluetooth LE (BLE) is a wireless personal area network technology designed by the Bluetooth Special Interest Group (SIG) aimed at novel applications in healthcare, fitness, security and home entertainment among many others. Compared to the classic Bluetooth it is intended to provide considerably reduced power consumption and cost while maintaining a similar communication range.

Bluetooth low energy is becoming ubiquitous in smart phone and hand held devices due to the recent native support by iOS and Android operating systems. The Bluetooth SIG defines numerous applications that would benefit from BLE deployment by defining several application profiles as specifications on how a device works for a particular application. Manufacturers are expected to implement the appropriate specifications for their devices to ensure compatibility.

Of particular interest is an application domain enabled by the existence of devices that emit BLE signals commonly referred to as BLE beacons. These are battery-powered devices (typical battery supported is between 30 to 3000 mAh but any battery can be supported depending on the form factor desired). Currently there are more than 30 manufacturers of BLE beacons in the market and many more are expected to appear in the months to come. These beacons implement one or more Bluetooth profiles, e.g., Apple has iBeacons, Qualcomm has Gimbal, and Motorola has MPact for providing proximity services. In this document, we use BLE beacons, beacon, and iBeacon interchangeably to refer to devices running Bluetooth LE in advertising mode.

BLE beacons emit a BLE signal that typically provides information about the identifier of the beacon device commonly referred to as Universal Unique Identifier (UUID) and two optional values typically referred to as the major and minor value. Such a signal has a range that depends on the battery of the beacon. Typical ranges are in the order to 30-50 meters unobstructed. Beacons allow to programmatically adjusting the UUID and major and minor values for a beacon. This technically allows anyone with basic programming skills to read these values from a beacon and program another beacon with the same values. In essence anyone can clone a particular beacon, an action that we refer to as beacon spoofing.

The beacon signal received by a device is associated with a RSSI (received signal strength indicator) value. RSSI is usually dependent on the beacon's base transmit power value, surrounding environment conditions, and distance from the beacon. The device receiving the signal or the cloud service (one or more computer servers located remotely and connected via internet) can utilize the RSSI value to determine a precise location of the receiver, based on a single or multiple readings. We refer to this component of the system as BLE location engine, which can reside either in the receiver device or the cloud. We discuss the location engine and its usage later in this report.

Most network interfaces, including Bluetooth devices, have an assigned unique identifier—MAC address—which is used as the network address for most IEEE 802 technologies. Consequently, all beacons have a MAC address which is the source address of the emitted signal. The Bluetooth low energy specifications allow for changing of the MAC address associated with the device on a frequent basis. Changing of the MAC address reduces the ability of a third party to track the beacon over a period of time, allowing it to stay private.

There is a need to address the spoofing and privacy issues associated with 802 protocol-based beacons.

### SUMMARY

In one aspect, a network security system is provided and may include one or more transmitters for broadcasting a data signal that carries information for triggering one or more processes, the one or more transmitters each being associated with an identifier; one or more coordinating components, associated with the one or more transmitters, and for providing the identifier uniquely to one or more users; one or more network connected devices (associated with the one or more users) that receive the identifier and process one or more data elements; a server computer or computer network service that receives the identifier and the one or more data elements, to trigger the one or more processes for the one or more users; and the system may include one or more security components that automatically modify the identifier based on a predetermined pattern known to each of the one or more coordinating components and the server computer or computer network service, thereby enabling the authentication of the one or more transmitters, and the authorization of the one or more processes for the one or more users.

In another aspect, the server computer or computer network service may be configured to analyze the identifier, provided uniquely for the one or more users, and compare the identifier with the automatically modified identifier based on the predetermined pattern; if there is a match between the identifier and the automatically modified identifier based on the predetermined pattern, authorizing the one or more processes for the one or more users; if there is not a match between the identifier and the automatically modified identifier based on the predetermined pattern, refusing the one or more processes for the one or more users.

In another aspect of the system, the one or more transmitters may include a beacon for use in advertising or digital commerce applications, and wherein the one or more security components may be configured to: i) prevent spoofing of the advertising beacon, ii) maintain privacy of the beacon, or iii) prevent tampering with, or unauthorized displacement of, the beacon.

In a still other aspect of the system, the information may relate to a marketing incentive, including an offer, a coupon, or a discount.

In yet another aspect of the system, the marketing incentive may be triggered based on the location of the one or more users, and the one or more transmitters are used to confirm that the location of the user may be the same as a predetermined venue for the marketing incentive.

In another aspect of the invention, a method of providing network security is provided and may include modifying based on a predetermined pattern an identifier (modified identifier) that is associated with one or more transmitters for broadcasting a data signal that carries information for triggering one or more processes for one or more users, using one or more coordinating components associated with the one or more transmitters; providing the modified identifier to one or more network connected devices (associated with the one or more users) and thereby providing an identifier for the one or more transmitters uniquely for the one or more users; the one or more network connected devices processing one or more data elements and connecting to a server computer or computer network service for authorizing the one or more processes for the one or more users, the one or more network connected devices providing the modified identifier to the server computer or computer network service; the server computer or computer network service analyzing the modified identifier and comparing the modified identifier to establish consistency with modification of the identifier using the predetermined pattern; and the server computer or computer network service, based on the comparing, either accepting the modified identifier and thereby initiating the one or more processes for the one or more users, or rejecting the modified identifier and thereby refusing the one or more processes for the one or more users.

In another aspect of the method, the one or more transmitters may include a beacon for use in advertising or digital commerce applications, and wherein the method may provide one or more of: i) preventing spoofing of the advertising beacon, ii) maintaining privacy of the beacon, or iii) preventing tampering with or unauthorized displacement of the beacon.

In a still other aspect of the method, the information may relate to a marketing incentive, including an offer, a coupon, or a discount.

In another aspect of the method, the marketing incentive may be triggered based on the location of the one or more users, and the one or more transmitters may be used to confirm that the location of the user may be the same as a predetermined venue for the marketing incentive.

### BRIEF DESCRIPTION OF THE FIGURES

In the drawings, embodiments of the present disclosure are illustrated by way of example. It is to be expressly understood that the description and drawings are only for the purpose of illustration and as an aid to understanding, and are not intended as a definition of the limits of the present disclosure.

Embodiments will now be described, by way of example only, with reference to the attached figures, wherein:

FIG. 1 provides a high-level block schematic of an interaction between a beacon, an application, and a complex network system or device, according to some example embodiments;

FIG. 2 provides a high-level block schematic of an interaction between a beacon, a fuzzy coordinating device, and a user device, to validate a beacon, according to some example embodiments;

FIG. 3 is a visual implementation of a beacon management system, according to some example embodiments;

FIG. 4 illustrates two beacons, each with a circular geofence, according to some example embodiments;

FIG. 5 is an illustrative diagram providing generic computer hardware and software for implementation of certain aspects, as detailed in the description.

### DETAILED DESCRIPTION

In one aspect of the invention, a network security system for authorizing one or more processes for or more users, based on the location of one or more users being the same as a venue associated with the one or more processes.

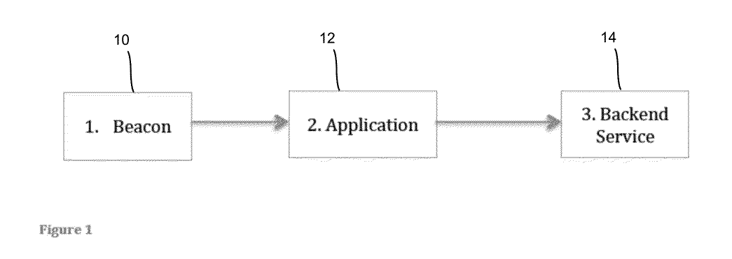

Referring to FIG. 1, one or more beacons 10 may be placed at a venue. Each beacon 10 may include one or more transmitters for broadcasting a data signal that carries information for triggering one or more processes. The processes may include providing a marketing incentive to the one or more users, such as an offer, a coupon or a discount. An identifier is associated with each beacon 10.

The one or more users are associated with an application 12. The application 12 include or be associated with a network connected device (not shown) such as a mobile device. The application 12 may be implemented as mobile application, or as a set of features implemented to the mobile device, or the mobile device may access the application 12 as a computer network service. The system may also include a computer server, computer network service, or backend service 14.

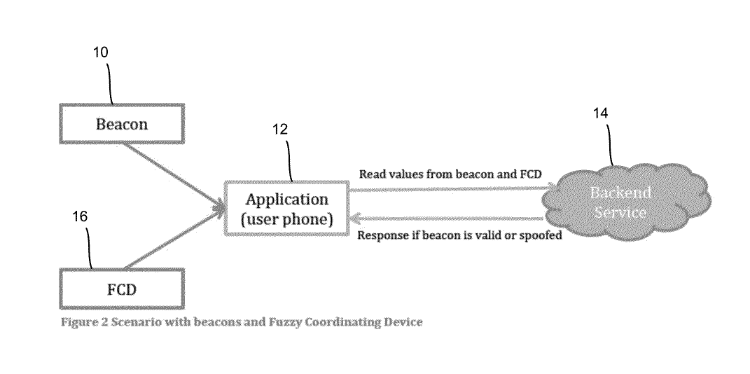

In one implementation, at the venue, one or more coordinating components are connected to the beacons 10, shown as the FCD 16, in FIG. 2. The coordinating components are configured to providing the identifier uniquely to one or more users.

The application 12 is associated with the one or more users, receives the identifier from the beacon 10, and processes one or more data elements.

The backend service 14, receives the identifier and the one or more data elements, to trigger the one or more processes for the one or more users.

The system comprises one or more security components that automatically modify the identifier based on a predetermined pattern known to each of the one or more coordinating components and the server computer or computer network service, thereby enabling the authentication of the one or more transmitters, and the authorization of the one or more processes for the one or more users.

In one implementation, the security components are implemented as part of the beacon 10 (or the FCD 16), and the backend service 14.

In another aspect, the backend service 14 is configured to: analyze the identifier, provided uniquely for the one or more users, and compare the identifier with the automatically modified identifier based on the predetermined pattern; if there is a match between the identifier and the automatically modified identifier based on the predetermined pattern, authorizing the one or more processes for the one or more users; if there is not a match between the identifier and the automatically modified identifier based on the predetermined pattern, refusing the one or more processes for the one or more users.

The backend service 14, and in some implementations the application 12, may implement one or more advertising or digital commerce applications. These may include a marketing incentive such as an offer, a coupon or a discount, where eligibility of the one or more users may require presence at the venue, or some action tied to the venue.

An obstacle in prior art technologies is the security of beacons, which may be subject to spoofing, privacy breaches or tampering/displacement. The system of the present invention is configured to: i) prevent spoofing of the advertising beacon, ii) maintain privacy of the beacon, or iii) prevent tampering with, or unauthorized displacement of, the beacon.

The embodiments of the devices, systems, methods, processes described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

In one aspect of the invention, a network security system for authorizing one or more processes for or more users, based on the location of one or more users being the same as a venue associated with the one or more processes.

The typical interaction that triggers such behaviors is illustrated in FIG. 1. A beacon 10 constantly emits a signal, for example a BLE signal. A device, for example a smart phone, which may run an application 12, may receive the signal and contacts a complex network system or service 14 to report the recorded beacon characteristics (e.g. UUID and major and minor, along with RSSI or other information). The complex network system or service 14 may include one or more components that may be configured to initiate one or more processes including the suitable knowledge to communicate a suitable action to the application, and may reside locally on the device or remotely in the cloud. The suitable action may be to trigger a particular behavior, for example, send content to the user, update a location in the map, record the action for future use, or any other action. If more than one BLE signal is sensed by the device, one or more of the BLE signals may be reported to the complex network system or service 14. The complex network system or service 14 may have the suitable logic to identify the action taking one or more of the BLE signals in consideration.

BLE beacons may be used in a number of scenarios, including, serving location-based behaviors and context-aware actions. This may be done by placing beacons at fixed and known locations. If these beacons are moved from their desired location or their transmit signal strength values are tampered with, it may lead to a potential security issue of beacon tampering or misplacement. This may result in the backend service triggering actions at the wrong location or not triggering them at all.

There may be three security issues that may arise when using beacons: beacon spoofing, beacon privacy, and beacon tampering.

One potential security issue may be beacon spoofing. It may be possible to clone a beacon by reading its UUID along with major and minor ID and reprogramming these values to another beacon. Several threats to normal application operations may be possible by such cloning. For example, assume a beacon A may be placed at a specific location X. The application may trigger a specific notification when a user may be near the location X, for example, the user receives a special discount coupon by visiting location X. The application may achieve this by sensing the beacon A in the vicinity of the device carried by the user, for example, a smart phone. It may be possible to spoof beacon A and beacon B may be created with the same UUID, major and minor and beacon B may be placed at location Y. Now the application may erroneously trigger the same discount coupon when the user may visit location Y with the user's device. As a result, the application may not be able to identify location X uniquely and therefore may be malfunctioning or may be revealing sensitive information at the wrong location or in the wrong context.

Another potential security issue may be beacon privacy. IEEE 802 devices, such as BLE beacons, may have a unique MAC identifier. While the main purpose of the MAC may be to act as a network address when sending or receiving any data, it may also be used to track the device. Similarly, since beacons may emit an advertising packet at periodic intervals, data contained in advertising packet may be sent to everyone in the vicinity. One may want to keep the beacons hidden or unknown to another device, unless the other device may be authorized to interact with them. Hence, privacy of the beacons may become essential.

Yet another potential security issue may be beacon tampering or misplacement. Deployment and management of any electronic devices at large scale may be a difficult proposition. Devices may need to be placed at a precise location. It may be important for the device not to be tampered with and it may be important for the device's power or battery to be operational. If the device is moved to an incorrect location, or if the configuration or setup of the device is tampered, or if the battery of the device runs out, the application may be exposed to potential issues. Some of these issues may concern security and privacy. For example, if a beacon is moved from location X to location Y, the application may trigger an action at the wrong location. Similarly, each beacon may be configured with a base transmit power which may play a role in determining the location. Again, tampering with any configuration, such as the base transmit power, may result in application malfunction. Similarly, as the battery of the beacon is removed or is drained, the application may stop behaving in the expected manner.

Beacons emitting BLE signals, often containing UUID, MAJOR, and MINOR may be referred to as characteristics emitted as part of the iBeacon protocol. The user's smartphone acts as the application. The complex network system or service 14, which may contain most of the logic, may in the cloud, that is, a remote datacenter accessible on the Internet. This scenario may be used for the sake of illustration, but all presented systems, techniques, and methods are general enough to apply to a variety of different scenarios.

For examples, these other scenarios include, but may not be limited to, the following variations.

In one aspect, beacons may be emitting signals on any IEEE 802 protocols. Beacon characteristics may be any set of data values beyond just the ones specified by the Apple's iBeacon protocol. Another example of a beacon may be a WiFi access point (AP), as each AP may have a unique MAC address (referred to as the BSSID) and may emit a Probe Request package at fixed intervals. While we may refer to Bluetooth in this document, WiFi AP may be another example of a beacon where all presented discussion applies. The beacons may have other capabilities as well, such as sensing the temperature, position via GPS, WiFi signals, and accelerometer.

Application may be running on a variety of devices such as wearables (smart watch, glasses), automobiles, smart appliances, computers, tablets etc. We may use the term user's phone and user's device to represent the application in the rest of the document for brevity.

The backend service may be hosted on the user's device itself, remotely on the cloud, or in hybrid mode across the local device and one or more remote servers. The device running the application may have a continuous connectivity to the complex network system or service 14 or it may be intermittent or periodic where buffering is used to send and receive data.

### Security and Privacy

In a venue with one or more beacons, each emitting a signal, for example a BLE signal with a fixed MAC address and other characteristics such as UUID, MAJOR and MINOR. It may be possible to spoof the beacon as its MAC and characteristics can be copied by other beacons.

In one embodiment, a fuzzy coordinator device (FCD) may be installed at the venue. The FCD may identify the location uniquely to the device or the user of the device. The FCD may change its characteristics with a known pattern to establish its authenticity to the user.

As an example, the FCD may be a Bluetooth iBeacon-like device which may change its characteristics in a pre-specified pattern. The pattern switch may take place at regular time intervals, e.g., every minute. A new MAJOR may be generated randomly and the MINOR may be set as the hash of a shared secret key and the new major. For example, the backend service and the FCD may have a shared secret key SKEY, then at the start of every minute:

MAJOR=random( )% 65536

MINOR=int(sha256(SKEY+MAJOR)) % 65536

In the above equations, random( ) may returns a random integer, into may convert a byte string to integer, and sha256 may be the SHA-256 hash algorithms. 65536 may be the maximum value of MAJOR and MINOR, and % may represent the modulo operation. If a shared key between the FCD and the backend service is not desirable, a public-private key approach may be employed. The FCD may have a unique private key PRIKEY and the backend service may know the public key PUBKEY for the FCD. Digital signature algorithms, such as PKCS1 may be utilized. The MAJOR value may be set to a random integer, and the MINOR value may be set to the digital signature computed using the PRIKEY and MAJOR. The backend service may then use the PUBKEY and observed MAJOR value to verify that the observed MINOR may be indeed set by the right PRIKEY, which the authentic FCD may do.

The above may be one possible embodiment of FCD, but several different variations may be possible depending on the use scenario. While Bluetooth may be a good choice of protocol as it may be easily available on different smartphones, in other embodiments, IEEE 802 protocols may be equally valid. In yet another embodiment, the choice of characteristics may be different from UUID/MAJOR/MINOR to any other attributes or data payload that may be emitted by the FCD. Many techniques from cryptography may be applicable for changing the characteristic values including a wide array of hashing algorithms or digital signature techniques (MD5, SHA, PKCS, DSA, ECDSA, public - - - private key cryptography etc.). In the rest of this application, for simplicity, the implementation example of FCD as a Bluetooth device is used, but the proposed technique may be applicable with many variations including the ones noted above.

The FCD when present in a location may establish its authenticity to a user. As its characteristics may not be static, but transient in a pattern known only to the backend service, it may not be possible to spoof the FCD.

In one embodiment, a Bluetooth device with power as FCD may be used. Such a device may be a computer or a router connected to a power source with either a built-in Bluetooth radio or a separate USB Bluetooth dongle. Such an FCD may emit signals for a configurable distance ranging from a few meters up to 50 meters. The device may be placed securely in a physical venue to avoid tampering and the cryptographic keys (SKEY or PRIKEY) may be placed in a secure hardware chip for further protection.

FIG. 2 illustrates how a backend service may be protected from beacon spoofing. In one embodiment, one or more FCD 16 may be present in a space along with beacons. A user carrying a device, for example a smartphone, may visit locations X and Y. The backend service may be running in the cloud (a remote datacenter accessible via internet from the smartphone). Location X may be the genuine location with a beacon B1, whereas the location Y may have beacon B2, a spoofed copy of beacon B1. Location X may also have the FCD device F1, whereas at location Y, either no FCD device is present or another FCD device F2 is present.

As the user visits the location X, the user's device may detect signals emitted by both B1 and F1. The observed UUID/MAJOR/MINOR of both B1 and F1 may be recorded by the user's device and may be sent to the backend service in the cloud for verification. The backend service may be able to verify if the values sent may be the ones generated by F1, and if this is the case, the authenticity of B1 belonging to the location X may be confirmed.

As the user visits the location Y, the user's device may detect signals emitted by both B2 and F2. The observed UUID/MAJOR/MINOR of both B2 and F2 may be recorded by the user's device and may be sent to the backend service in the cloud for verification. If no FCD is present at the location Y, then the backend service may discard the sent values as invalid and raise an alert to notify for a possible spoofing. If values from F2 are present, the backend service may not be able to match the values anticipated from F1 as the secret key of F1 (SKEY or PRIKEY) may not be known to F2. The backend service may again be able to discard these readings as being spoof.

The secret keys (SKEY or PUBKEY/PRIKEY) may be changed periodically for additional security by communication of FCD with the backend service.

This methodology may present a way to protect against proofing of any beacon in the market. It may enable the cloud service to operate irrespective of any beacon manufacturer and may offer security of operations and protection against anyone trying to enforce malicious behavior by spoofing the beacons.

In another embodiment, a complementary technique to secure beacons and assure the normal operation of an application is disclosed. User devices, for example smartphones, may typically be GPS enabled, which may mean that they may be capable of communicating the latitude and longitude values of their location utilizing GPS satellites. Even when the GPS may not be enabled or available, approximate network location, using telecom service provider's infrastructure, may be available to most modern user devices, for example smartphones. In addition, popular smartphone operating systems may report their location as inferred by sensing the local WiFi BSSIDs and SSIDs by performing a WiFi scan.

Both these pieces of information may be reported back to a cloud service by each smartphone after beacon scans. The backend service may maintain a mapping of each beacon with its install location. Such a map may contain beacon characteristics (such as UUID, MAJOR, MINOR, MAC address) mapped to a location (street address, latitude, longitude, list of nearby WiFi SSID and BSSID values).

As a user visits a location X where beacons may be detected, one or more beacon characteristics may sent to the backend service along with the last recorded location information (for example, latitude, longitude, WiFi BSSIDs and SSIDs, and record time). The location information, derived from GPS, mobile network or WiFi signals, may be computed at the time of the beacon scan or on a periodic basis (say every 60 seconds) for preserving the phone battery. The backend cloud service may use the beacon location mapping to see if the sent location address may be within a specified threshold of the expected location, say, within 200 meters. If this test fails, the backend service may raise an alert for a possible spoof and notify the application running on the user's phone and appropriate authorities.

In some embodiments, if latitude/longitude data may not be available, the list of WiFi BSSIDs may be used. The WiFi BSSIDs may refer to the MAC address of wireless access points issuing Probe Requests. As an example, a typical urban shopping store may have 10-20 unique BSSIDs that may be used to authenticate the location. Since the BSSIDs may change over time, a threshold may be used such that the location may be verified to be genuine only if at least one or more BSSIDs reported by the user's phone match the ones listed in beacon location mapping table. While it may be possible to spoof the BSSIDs in theory, doing so in real-life may be challenging and nearly impossible. If WiFi information may not be available and if the user may be indoors where the network or GPS location may not be available either, last known location may apply as most indoor environments span less than few hundred meters.

### Beacon Deployment and Management

Deploying and managing a plurality of beacons across diverse geographies may be a non-trivial task. Several important issues may arise, such as keeping track of the location of each, setting and changing the regions sensitivity (geofence) around each beacon, monitoring the health of the beacons (for example, battery levels of the beacons), and issuing alerts to suitable stakeholders when their attention is needed. Typical alerts may signify when a beacon's battery life is running low and has to be replaced. Similarly, when one of beacons is misplaced or tampered with, it may need to be reported. If the backend service detects any beacon spoofing, as described in the previous section, additional alerts may be raised.

A beacon management system (BMS) that is designed to address these challenges is disclosed. A BMS is a system that may all issues around deploying, managing and securing a large number of beacons. Upon deployment, a BMS may store the floor plan of each location. On the floor plan, the position of each beacon may be identified (along with the beacon characteristics, such as their MAC, UUID, major and minor). If the location has a new layout or the beacons are moved, the floor plans and associated locations may be updated in the BMS. Location information (latitude, longitude, street address, list of nearby WiFi BSSID/SSID), configuration information (transmit power, advertising interval), and other metadata may also be stored by the BMS.

Similarly, along with each beacon, the BMS may record the region around the beacon, namely the physical area that upon a device's entry, a mobile device may be considered to be in the region (geofence) of that beacon. This region may be expressed in some measurement unit (meters) or signal strength threshold and may be adjusted anytime at the BMS. A BMS may facilitate the visualization of the floor plans, the locations of the beacons, and the geofence around each beacon, which may facilitate easy administration of the entire deployment.

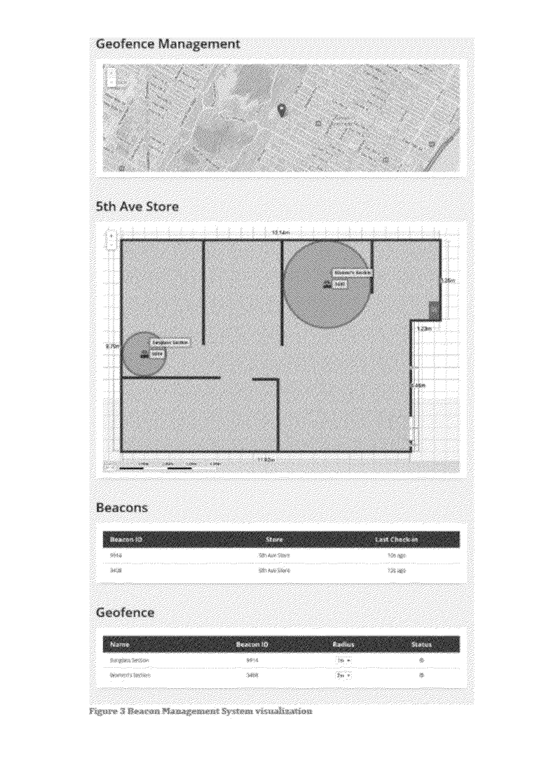

FIG. 3 illustrates a visual implementation of the BMS. Different embodiments of the BMS may be possible.

In some embodiments, one or more methods for collecting data may be used.

In some embodiments, a user's device, such as the user's smartphone, may be used to monitor the beacon. A user device running the application (for example, user smartphone) that may interact with the locations managed in the BMS may communicate back to the BMS the various parameters about the beacon signals it receives. These parameters may include the beacon characteristics (MAC, UUID, MAJOR, MINOR) and other available data, which may include the battery level, temperature, accelerometer information, GPS coordinates etc. for the beacon. The BMS, upon receiving this information from the application (user's phone), may conduct various operations, including determining if a beacon has been tampered (i.e., changed location or has been spoofed), may record the battery level of the beacon and may alerts, for example, upon the battery level dropping below a set threshold. Similarly, the BMS may be tasked to issue alerts if the beacon has been spoofed, misplaced, or tampered with.

In some embodiments, the BMS may be deployed to receive information about the beacons deployed. A dedicated hardware device, Beacon Management Device (BMD), may be used. For iBeacons and other Bluetooth beacons, the BMD may be a mini computer or router with Bluetooth capabilities and Internet connectivity to the backend service running on the cloud. Typically the range of such BMDs may be around 35 m-50 m and one may be enough to cover all beacons in a typical space. For larger deployments, more BMDs may be positioned. The BMD may receive information regarding beacon, for example, the UUID of each beacon, the major and minor and battery level, and may send that information to the BMS for processing, such as issuing alerts or identifying spoofed beacons.

In some embodiments, a BMS may deploy two different ways to collect information about the beacons deployed. The first may be a form of crowdsourcing in which a user's mobile device may be utilized for data collection from the beacons and may send the data back to the BMS. The second may involve the deployment of a specific hardware device that may perform data collection and may send the information back to the BMS.

In some embodiments, once the BMD collects the information, it may issue alerts for battery levels and other deployment issues.

In some embodiments, the use of FCD or user location data may facilitate the BMS to identify beacon spoofing and issuing alerts.

Since BMS may record data on beacons that may be in close vicinity to the BMS, if one or more beacon may be present nearby (say, within a few meters), this information may also be used to determine beacon misplacement or tampering. In some embodiments, if a location has three beacons within a 10 ft distance, and if the BMS records data coming from two beacons over the last 10 minutes, it may be possible to infer that either the third beacon has been misplaced or it has been tampered with. This data may come from either a dedicated BMD or a user's device.

### Privacy Preserving Methods

In some embodiments, beacons may emit signals at constant time intervals. These signals may contain information about the beacon, such as its MAC, UUID, MAJOR and MINOR along with other data such as battery level, temperature, accelerometer information or GPS location depending on beacon hardware capabilities. Some of this information may be private, and may need to be preserved. Techniques that may be used to control emission of such information in un-authorized scenarios are disclosed.

In some embodiments, the beacons may be aware of context. It may be possible for a beacon to receive signals emitted by other beacons nearby or FCD. While this may not be possible for all beacons, those equipped with a processing unit may do this. Beacons that may be equipped with a processing unit to receive signals emitted by other beacons nearby or FCD may be described as context aware.

The beacons may be configured such that the beacons may not emit private information unless the beacons may be in a trusted environment. In some examples, the trust in an environment may be established by sensing either a FCD or known beacons nearby. In some embodiments, the beacon may stop transmitting private information if it may be misplaced or stolen and moved to a new location where the FCD or other known beacons may not be present.

In some embodiments, the context aware beacons may have other sensors as well, such as GPS-based location, temperature, and accelerometer, infrared camera, which may also be used to detect an unauthorized access. For example, a context aware beacon may be installed at a wall in an indoor location, which may be temperature-controlled, for example, to 23° C. The context aware beacon may continuously monitor the context, for example, nearby beacons, FCD, temperature, accelerometer information. If it senses the temperature to be a different temperature from the controlled temperature, for example 30° C., then it may shut itself off as this action may indicate that the temperature it has been changed. Similarly, the accelerometer may indicate a change in position. Once the beacon takes a privacy-protecting action (e.g. disable itself or change MAC address), it may require either manual intervention or specific password for reconfiguration.

In some embodiments, privacy may be preserved by using a beacon management device (BMD) or a user's device.

Most beacons may support remote configuration to enable or disable them. Such remote configuration may require the configuring device to send a secret password to the beacon along with the action command. In some embodiments, a Beacon Management Service (BMS) running remotely may send a command action to the beacon to disable itself if a security alert is raised.

If the BMS detects security issues, e.g., beacon spoofing, or misplacement, then it may issue a command for disabling a beacon or all beacons until the issue may be investigated. In some embodiments, the BMS may store the secret password for each beacon. The secret password may be needed to change the beacon settings, often by connecting over Bluetooth protocol. The secret password along with the command to deactivate may be sent to the beacon.

In some embodiments, if a BMD is present in the location, the secret password along with the command to deactivate may be sent to the beacon by the BMD.

In some embodiments, if no BMD is present, any user device running the application and present in the vicinity may retrieve the command from the BMS and may relay it to the beacon.

In some embodiments, it may not be necessary to completely disable the beacon. In some cases, a simple switch of characteristic values (e.g., MAC address) may suffice.

### Using Staff Phones and Other Persistent Devices

In some embodiments, the utility of a dedicated hardware may be present at the location the beacons may be installed. This hardware may provide FCD capabilities for trusted operation and authentication or may provide BMD capabilities for beacon management. In some embodiments, a single hardware device may provide both FCD and BMD functionalities.

In some embodiments, a device, such as a computer (such as Raspberry Pi running an operating system like Linux) or network router (running any operating system such as OpenWRT or ddWRT) may be used for this purpose. However, this may not be feasible given the additional cost of purchasing and deploying such a device in physical locations.

In some embodiments, an existing device already present at the location where the beacons may be install may also provide FCD/BMD capabilities. For example, existing WiFi routers, smart appliances (e.g., Nest thermostat, camera surveillance devices, Point of Sale systems, and smart refrigerators) may be used for such a deployment. A device, which may be present at the location of interest capable of running a custom software application, may be used.

In some embodiments, staff and personnel phones and devices may be used. It may not be required to use devices that may always be present in the location or may be stationary. Non-stationary devices may also provide both FCD and BMD capabilities. Devices carried by the staff and authorized personal, for example smartphones, may be an ideal candidate for such a device. The term “staff phones” may be used to generally refer to phones and other devices (e.g., wristbands like Fitbit, glasses like Google Glasses, smart clothing) carried by all authorized personnel.

In one example, a typical retail location may have one or more staff members who may have one or more phones capable for running a custom application (smartphones may have such capabilities). A custom management application may be installed on these phones such that the custom management application may run in the background. The management application may easily emit unique signals acting as FCD, collect signals emitted from nearby beacons and relay to BMS, and relay commands from BMS to beacons.

In some embodiments, multiple staff members may have this custom management application, and as long as at least one of the multiple staff members is present in the location, both FCD and BMD capabilities may be provided. Even if these devices may not be present at the location at all times, this approach may provide sufficient security preserving, privacy protecting and management functionalities. The management application may automatically turn itself ON and OFF based on the location of the staff phone and time schedules. If the staff phone is stolen or lost, its management application may be deactivated immediately.

### Location Inference

One application facilitated by beacons may be identification of the precise location of a user's device inside a space. As the user moves, relative to different geofences (spaces), such as entering and exiting the geofence, different actions may be triggered. For example, as a user visits near a shoe display in a store, a coupon with a discount on the shoe may be sent to the user's device.

In some embodiments, entry and exit from a geofence may be a feature for one or more applications. Different types of geofences may be created by beacons and may be applied.

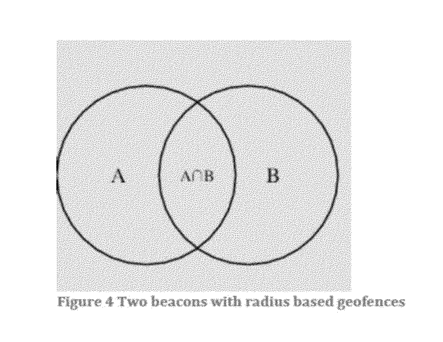

FIG. 4 illustrates two beacons, A and B, on a floor plan. A circle is drawn around each beacon to represent a circular area.

A circular geofences, defined as a circle of a specified radius around a single beacon, may be one embodiment of a geofence. The radius may typically be specified as a threshold on the received signal strength value (RSSI). As the beacon emits the signals, the RSSI may be recorded by the user device, and may easily facilitate detection of such geofences. Since the RSSI may relate to a distance, a geofence may be referenced by radius in meters or feet.

As illustrated in FIG. 4, if the beacon A is used, the circle around A will be the associated geofence.

In some embodiments, a type of geofence may utilize the same RSSI-based circular area around beacons and may use more than one beacon. The geofence may be defined as a list of beacons, RSSI-threshold for each of the beacons, and the number NMIN of minimum match of beacons. When a user's device or application records the signals from multiple beacons in the specified list, at least NMIN of these signals may be stronger than the specified RSSI threshold.

In one embodiment as illustrated in FIG. 4, if both beacons A and B are used, and if NMIN may be set to 1 then the union of both the circles may constitute the geofence. Similarly if NMIN may be set to 2, then the intersection of the two circles may be the resulting geofence. Hence, by using multiple beacons and varying the values of NMIN, different complex shaped geofences may be constructed as required.

In some embodiments, multiple beacon geofences may be based on location triangulation. If three or more beacon signals are recorded by the user's device, the signals may be utilized together to find a precise location of the user on a floor plan, for example, as <x, y> coordinates. RSSI-based triangulation techniques may be used to perform such an inference. If the exact <x, y> coordinates are available, the geofences may no longer need to conform to any predetermined shape, for example, of a circle or intersection/union of multiple circles. The geofences that may not conform to any predetermined shape may be implemented as arbitrary areas on a floor plan and may be enabled by triangulating beacon signals from three or more beacons.

In some embodiments, a geofence may be implemented by combining signals from multiple 802 protocols, such as Bluetooth and WiFi. Embodiments of geofences described in this application may be applicable to Bluetooth and WiFi based signals.

In some embodiments, a geofence may be defined with a combination of Bluetooth and WiFi. For example, the geofences may specify a RSSI threshold around a Bluetooth beacon and a different RSSI threshold for a WiFi BSSID, and the user may satisfy both conditions to be considered inside the geofence defined with the combination of Bluetooth and WiFi.

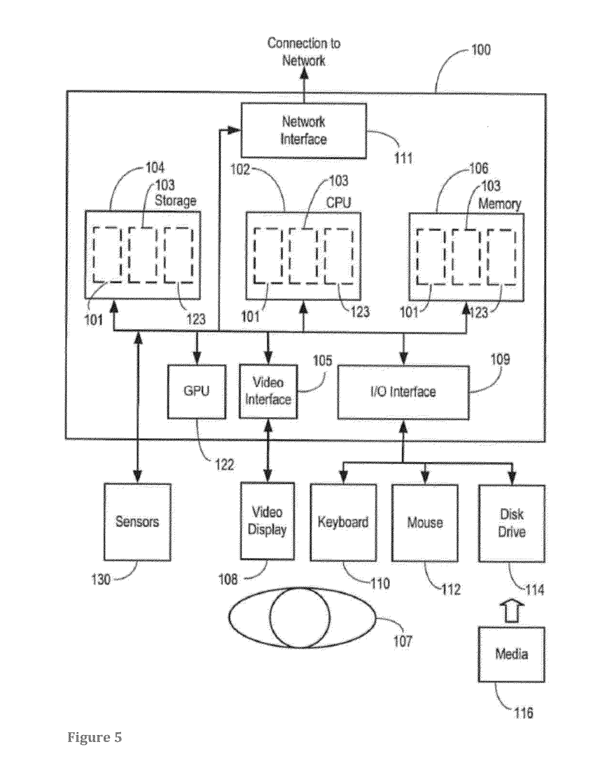

The present system and method may be practiced in various embodiments. A suitably configured computer device, and associated communications networks, devices, software and firmware may provide a platform for enabling one or more embodiments as described above. By way of example, FIG. 5 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

Computing device 100 is operable to register and authenticate users (using a login, unique identifier, and password for example) prior to providing access to applications, a local network, network resources, other networks and network security devices. Computing devices 100 may serve one user or multiple users.

The present system and method may be practiced on computer devices including a desktop computer, laptop computer, tablet computer or wireless handheld having the ability to connect with the Internet and/or various social networking platforms and/or promotional offer inventory systems. In some embodiments, the systems and methods may be performed on distributed networking devices, such as devices arranged in a “cloud computing” implementation.

The computing device components may be connected in various ways including directly coupled, indirectly coupled via a network, and distributed over a wide geographic area and connected via a network (which may be referred to as “cloud computing”).

For example, and without limitation, a computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods and processes described herein.

As will be further understood by those skilled in the relevant arts, significant advantage may be realized through the full or partial automation of any of the processes described above, or portions thereof. Such automation may be provided in any suitable manner, including for example the use of automatic data processors executing suitably-configured, coded, machine-readable instructions using a wide variety of devices, some of which are known and others of which will doubtless be developed hereafter. Processor(s) suitable for use in such implementations can comprise any one or more data processor(s), computer(s), and/or other system(s) or device(s), and necessary or desirable input/output, communications, control, operating system, and other devices or components, including software, that are suitable for accomplishing the purposes described herein. For example, a suitably-programmed general-purpose data processor provided on one or more circuit boards will suffice.

The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation.

It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

The mobile application of the present disclosure may be implemented as a web service, where the mobile device includes a link for accessing the web service, rather than a native application.

The functionality described may be implemented to various mobile platforms, including the iOS™ platform, ANDROID™, WINDOWS™ or BLACKBERRY™.

It will be appreciated by those skilled in the art that other variations of the embodiments described herein may also be practiced without departing from the scope of the disclosure. Other modifications are therefore possible.

In further aspects, the disclosure provides systems, devices, methods, and computer programming products, including non-transient machine-readable instruction sets, for use in implementing such methods and enabling the functionality described previously.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or step.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the disclosure, the scope of which is defined by the claims.

What is claimed is:

1. A network security system comprising:
one or more transmitters for broadcasting a data signal that carries information for triggering one or more processes, the one or more transmitters each being associated with an identifier;
one or more coordinating components, associated with the one or more transmitters, and for providing the identifier uniquely to one or more users;
one or more network connected devices (associated with the one or more users) that receive the identifier and process one or more data elements;
a server computer or computer network service that receives the identifier and the one or more data elements, to trigger the one or more processes for the one or more users; and
the system comprising one or more security components that automatically modify the identifier based on a predetermined pattern known to each of the one or more coordinating components and the server computer or computer network service, thereby enabling the authentication of the one or more transmitters, and the authorization of the one or more processes for the one or more users.

2. The system of claim 1, wherein the server computer or computer network service is configured to:
analyze the identifier, provided uniquely for the one or more users, and compare the identifier with the automatically modified identifier based on the predetermined pattern;
if there is a match between the identifier and the automatically modified identifier based on the predetermined pattern, authorizing the one or more processes for the one or more users;
if there is not a match between the identifier and the automatically modified identifier based on the predetermined pattern, refusing the one or more processes for the one or more users.

3. The system of claim 1, wherein the one or more transmitters include a beacon for use in advertising or digital commerce applications, and wherein the one or more security components are configured to: i) prevent spoofing of the advertising beacon, ii) maintain privacy of the beacon, or iii) prevent tampering with, or unauthorized displacement of, the beacon.

4. The system of claim 1, wherein the information relates to a marketing incentive, including an offer, a coupon, or a discount.

5. The system of claim 4, wherein the marketing incentive is triggered based on the location of the one or more users, and the one or more transmitters are used to confirm that the location of the user is the same as a predetermined venue for the marketing incentive.

6. The system of claim 1 comprising a secure communication infrastructure for exchanging credentials and authenticating the one or more transmitters to one or more of the network connected devices or the server computer or computer network service.

7. A method of providing network security comprising:
(a) modifying based on a predetermined pattern an identifier (modified identifier) that is associated with one or more transmitters for broadcasting a data signal that carries information for triggering one or more processes for one or more users, using one or more coordinating components associated with the one or more transmitters;
(b) providing the modified identifier to one or more network connected devices (associated with the one or more users) and thereby providing an identifier for the one or more transmitters uniquely for the one or more users;
(c) the one or more network connected devices processing one or more data elements and connecting to a server computer or computer network service for authorizing the one or more processes for the one or more users, the one or more network connected devices providing the modified identifier to the server computer or computer network service;
(d) the server computer or computer network service analyzing the modified identifier and comparing the modified identifier to establish consistency with modification of the identifier using the predetermined pattern; and
(e) the server computer or computer network service, based on the comparing, either accepting the modified identifier and thereby initiating the one or more processes for the one or more users, or rejecting the modified identifier and thereby refusing the one or more processes for the one or more users.

8. The method of claim 7, wherein the one or more transmitters include a beacon for use in advertising or digital commerce applications, and wherein the method provides one or more of: i) preventing spoofing of the advertising beacon, ii) maintaining privacy of the beacon, or iii) preventing tampering with or unauthorized displacement of the beacon.

9. The method of claim 7, wherein the information relates to a marketing incentive, including an offer, a coupon, or a discount.

10. The method of claim 9, wherein the marketing incentive is triggered based on the location of the one or more users, and the one or more transmitters are used to confirm that the location of the user is the same as a predetermined venue for the marketing incentive.
